(19) United States
(12) Patent Application Publication
(10) Pub. No.: US 2026/0292613 A1
(43) Pub. Date: Sep. 24, 2026

(54) CELL RESELECTION METHOD AND APPARATUS, TERMINAL, AND NETWORK SIDE DEVICE

(71) Applicant: VIVO MOBILE COMMUNICATION CO., LTD., Dongguan (CN)

(72) Inventors: Ranran HE, Dongguan (CN); Xiaodong YANG, Dongguan (CN)

(73) Assignee: VIVO MOBILE COMMUNICATION CO., LTD., Dongguan (CN)

(21) Appl. No.: 19/658,872

(22) Filed: Apr. 27, 2026

Related U.S. Application Data
(63) Continuation of application No. PCT/CN2024/134806, filed on Nov. 27, 2024.

(30) Foreign Application Priority Data
Oct. 27, 2023 (CN) 202311410593.4

(51) Int. Cl. H04W 36/00; H04W 36/08

(52) U.S. Cl. CPC H04W 36/0061; H04W 36/08

(57) ABSTRACT

A cell reselection method and apparatus, a terminal, and a network side device are provided. The cell reselection method includes: receiving, by a terminal, a first indication sent by a network side device, where the first indication is used to instruct at least one of the following: ignoring or not applying, by the terminal, a first configuration in a cell reselection procedure, or applying, by the terminal, only a second configuration in the cell reselection procedure; and performing, by the terminal, a target operation according to the first indication, where the target operation includes at least one of the following: ignoring or not applying the first configuration of a target cell in the cell reselection procedure; or applying only a configuration corresponding to the target cell in the second configuration in the cell reselection procedure.

### CROSS-REFERENCE TO RELATED APPLICATIONS

This application is a continuation of International Application No. PCT/CN2024/134806, filed Nov. 27, 2024, which claims priority to Chinese Patent Application No. 202311410593.4, filed Oct. 27, 2023. The entire contents of each of the above-referenced applications are expressly incorporated herein by reference.

### TECHNICAL FIELD

This application pertains to the field of communication technologies, and specifically relates to a cell reselection method and apparatus, a terminal, and a network side device.

### BACKGROUND

In network deployment of related technologies, there may be an unauthorized network (“spider” network in which a pseudo base station may be installed), and the network may be configured to enable a terminal to move to a lower-version network, making the terminal susceptible to attacks. For example, by exploiting the terminal's inability to verify an identity of the lower-version network, fraudulent or spam messages are sent to the terminal, resulting in losses for the terminal's user. Currently, a network side device cannot prevent the terminal camping on the unauthorized network from performing mobility management based on or in violation of the configuration of the unauthorized network, thus failing to stop the terminal from moving to or accessing an inappropriate network (for example, a lower-version network). Consequently, a risk of a network attack on the terminal cannot be controlled.

### SUMMARY

Embodiments of this application provide a cell reselection method and apparatus, a terminal, and a network side device.

According to a first aspect, a cell reselection method is provided. The method is performed by a terminal and includes:
receiving, by a terminal, a first indication sent by a network side device, where the first indication is used to instruct at least one of the following: ignoring or not applying, by the terminal, a first configuration in a cell reselection procedure, or applying, by the terminal, only a second configuration in the cell reselection procedure; and
performing, by the terminal, a target operation according to the first indication, where the target operation includes at least one of the following:
ignoring or not applying the first configuration of a target cell in the cell reselection procedure; or
applying only a configuration corresponding to the target cell in the second configuration in the cell reselection procedure, where
the target cell is a candidate cell for performing cell reselection by the terminal or a serving cell of the terminal, the first configuration and the second configuration are used in the cell reselection procedure, and the second configuration is different from the first configuration.

According to a second aspect, a cell reselection method is provided. The method is performed by a network side device and includes:
sending, by a network side device, a first indication to a terminal, where the first indication is used to instruct at least one of the following: ignoring or not applying, by the terminal, a first configuration in a cell reselection procedure, or applying, by the terminal, only a second configuration in the cell reselection procedure; and
the first configuration and the second configuration are used in the cell reselection procedure, and the second configuration is different from the first configuration.

According to a third aspect, a cell reselection apparatus is provided. The apparatus is applied to a terminal and includes:
a receiving module, configured to receive a first indication sent by a network side device, where the first indication is used to instruct at least one of the following: ignoring or not applying, by the terminal, a first configuration in a cell reselection procedure, or applying, by the terminal, only a second configuration in the cell reselection procedure; and
an execution module, configured to perform a target operation according to the first indication, where the target operation includes at least one of the following:
ignoring or not applying the first configuration of a target cell in the cell reselection procedure; or
applying only a configuration corresponding to the target cell in the second configuration in the cell reselection procedure, where
the target cell is a candidate cell for performing cell reselection by the terminal or a serving cell of the terminal, the first configuration and the second configuration are used in the cell reselection procedure, and the second configuration is different from the first configuration.

According to a fourth aspect, a cell reselection apparatus is provided. The apparatus is applied to a network side device and includes:
a sending module, configured to send a first indication to a terminal, where the first indication is used to instruct at least one of the following: ignoring or not applying, by the terminal, a first configuration in a cell reselection procedure, or applying, by the terminal, only a second configuration in the cell reselection procedure; and
the first configuration and the second configuration are used in the cell reselection procedure, and the second configuration is different from the first configuration.

According to a fifth aspect, a terminal is provided. The terminal includes a processor and a memory, the memory stores a program or an instruction that can be run on the processor, and the program or the instruction is performed by the processor to implement the steps of the method according to the first aspect.

According to a sixth aspect, a terminal is provided, including a processor and a communication interface. The communication interface is configured to receive a first indication sent by a network side device, where the first indication is used to instruct at least one of the following: ignoring or not applying, by the terminal, a first configuration in a cell reselection procedure, or applying, by the terminal, only a second configuration in the cell reselection procedure; and the processor is configured to perform a target operation according to the first indication, where the target operation includes at least one of the following:
ignoring or not applying the first configuration of a target cell in the cell reselection procedure; or
applying only a configuration corresponding to the target cell in the second configuration in the cell reselection procedure, where
the target cell is a candidate cell for performing cell reselection by the terminal or a serving cell of the terminal, the first configuration and the second configuration are used in the cell reselection procedure, and the second configuration is different from the first configuration.

According to a seventh aspect, a network side device is provided. The network side device includes a processor and a memory, the memory stores a program or an instruction that can be run on the processor, and the program or the instruction is performed by the processor to implement the steps of the method according to the second aspect.

According to an eighth aspect, a network side device is provided, including a processor and a communication interface. The communication interface is configured to send a first indication to a terminal, where the first indication is used to instruct at least one of the following: ignoring or not applying, by the terminal, a first configuration in a cell reselection procedure, or applying, by the terminal, only a second configuration in the cell reselection procedure; and
the first configuration and the second configuration are used in the cell reselection procedure, and the second configuration is different from the first configuration.

According to a ninth aspect, a readable storage medium is provided. The readable storage medium stores a program or an instruction, and the program or the instruction is performed by a processor to implement the steps of the method according to the first aspect or the steps of the method according to the second aspect.

According to a tenth aspect, a wireless communication system is provided, including a terminal and a network side device. The terminal may be configured to perform the steps of the method according to the first aspect, and the network side device may be configured to perform the steps of the method according to the second aspect.

According to an eleventh aspect, a chip is provided. The chip includes a processor and a communication interface, the communication interface is coupled to the processor, and the processor is configured to run a program or an instruction to implement the method according to the first aspect or the method according to the second aspect.

According to a twelfth aspect, a computer program/program product is provided. The computer program/program product is stored in a storage medium, and the program/program product is performed by at least one processor to implement the steps of the method according to the first aspect or the second aspect.

In the embodiments of this application, a terminal receives a first indication sent by network side device, and performs the following target operation according to the first indication: ignoring or not applying a first configuration of a target cell in a cell reselection procedure, or applying only a configuration corresponding to the target cell in the second configuration in the cell reselection procedure. In this way, the network side device configures behavior of the terminal in the cell reselection procedure, so that the terminal can perform the target operation in the cell reselection procedure according to the configuration of the network side device, the operation behavior of the terminal is more controllable, and the network side device can learn the operation behavior of the terminal in the cell reselection procedure. This helps the network side device make timely adjustment when the terminal accesses an inappropriate network, so that the terminal is prevented from suffering a network attack, and a risk of the network attack on the terminal is more controllable.

### BRIEF DESCRIPTION OF DRAWINGS

FIG. 1 is a block diagram of a wireless communication system to which the embodiments of this application can be applied;

FIG. 2 is a flowchart of a cell reselection method according to an embodiment of this application;

FIG. 3 is a flowchart of another cell reselection method according to an embodiment of this application;

FIG. 4 is a structural diagram of a cell reselection apparatus according to an embodiment of this application;

FIG. 5 is a structural diagram of another cell reselection apparatus according to an embodiment of this application;

FIG. 6 is a structural diagram of a communication device according to an embodiment of this application;

FIG. 7 is a structural diagram of a terminal according to an embodiment of this application;

FIG. 8 is a structural diagram of a network side device according to an embodiment of this application; and

FIG. 9 is a structural diagram of another network side device according to an embodiment of this application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill based on the embodiments of this application shall fall within the protection scope of this application.

In this application, the terms “first”, “second”, and the like are intended to distinguish between similar objects but do not describe a specific order or sequence. It should be understood that the terms used in such a way are interchangeable in proper circumstances so that the embodiments of this application can be implemented in orders other than the order illustrated or described herein. Objects classified by “first” and “second” are usually of a same type, and the number of objects is not limited. For example, there may be one or more first objects. In addition, “or” in this application means at least one of connected objects. For example, “A or B” covers three schemes. Scheme 1: including A but excluding B; Scheme 2: including B but excluding A; Scheme 3: including both A and B. The character “/” generally indicates an “or” relationship between the associated objects.

The term “indication” in this application may be either a direct indication (or an explicit indication) or an indirect indication (or an implicit indication). A direct indication may be understood as that a sender explicitly informs a recipient of content such as specific information, an operation to be performed, or a requested result in a sent indication. An indirect indication may be understood as that a recipient determines corresponding information based on an indication sent by a sender, or makes a judgment and determines an operation to be performed or a requested result based on a judgment result.

It should be noted that technologies described in the embodiments of this application are not limited to a Long Term Evolution (LTE)/LTE-Advanced (LTE-A) system, and may further be applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-carrier Frequency Division Multiple Access (SC-FDMA), or other systems. The terms “system” and “network” in the embodiments of this application may be used interchangeably. The technologies described can be applied to both the systems and the radio technologies mentioned above as well as to other systems and radio technologies. The following describes a New Radio (NR) system for example purposes, and NR terms are used in most of the following descriptions. These technologies can also be applied to systems other than the NR system, such as a 6th generation (6G) communication system.

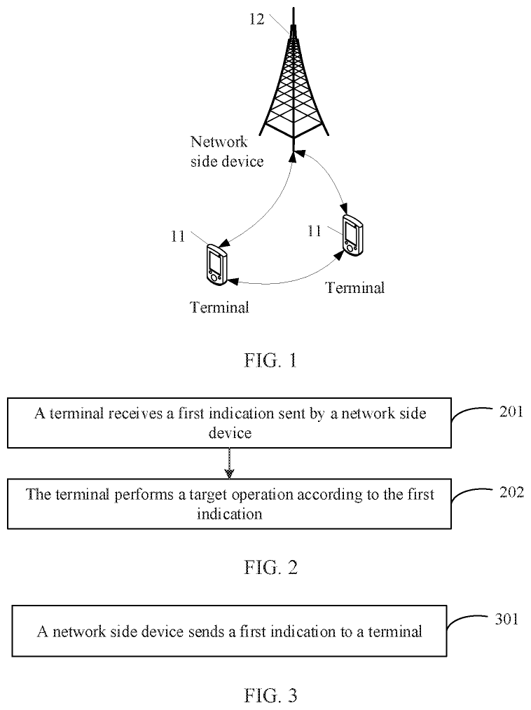

FIG. 1 is a block diagram of a wireless communication system to which the embodiments of this application can be applied. The wireless communication system includes a terminal 11 and a network side device 12. The terminal 11 may be a terminal side device such as a mobile phone, a tablet personal computer, a laptop computer, a notebook computer, a Personal Digital Assistant (PDA), a palmtop computer, a netbook, an Ultra-mobile Personal Computer (UMPC), a Mobile Internet Device (MID), an Augmented Reality (AR) device, a Virtual Reality (VR) device, a robot, a wearable device, a flight vehicle, Vehicle User Equipment (VUE), shipborne equipment, Pedestrian User Equipment (PUE), a smart home (a home device with a wireless communication function, such as a refrigerator, a television, a washing machine, or a furniture), a game console, a Personal Computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet, and a smart chain), a smart wrist strap, a smart dress, and the like. The vehicle user equipment may also be referred to as an in-vehicle terminal, an in-vehicle controller, an in-vehicle module, an in-vehicle component, an in-vehicle chip, or an in-vehicle unit. It should be noted that a specific type of the terminal 11 is not limited in the embodiments of this application. The network side device 12 may include an access network device or a core network device. The access network device may also be referred to as a Radio Access Network (RAN) device, a radio access network function, or a radio access network unit. The access network device may include a base station, a Wireless Local Area Network (WLAN) Access Point (AP), a Wireless Fidelity (WiFi) node, or the like. The base station may be referred to as a NodeB (NB), an evolved NodeB (eNB), a next generation NodeB (gNB), a new radio NodeB (NR NodeB), an access point, a Relay Base Station (RBS), a Serving Base Station (SBS), a Base Transceiver Station (BTS), a radio base station, a radio transceiver, a Basic Service Set (BSS), an Extended Service Set (ESS), a home NodeB (HNB), a home evolved NodeB, a Transmission Reception Point (TRP), or another appropriate term in the field. As long as a same technical effect is achieved, the base station is not limited to a specified technical term. It should be noted that, in this application, only a base station in an NR system is used as an example, and a specific type of the base station is not limited.

The core network device may include but is not limited to at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF), an Edge Application Server Discovery Function (EASDF), Unified Data Management (UDM), a Unified Data Repository (UDR), a Home Subscriber Server (HSS), a Centralized network configuration (CNC), a Network Repository Function (NRF), a Network Exposure Function (NEF), a Local NEF (L-NEF), a Binding Support Function (BSF), an Application Function (AF), or the like. It should be noted that, in the embodiments of this application, only a core network device in an NR system is used as an example for description, and a specific type of the core network device is not limited.

For better understanding, the relevant concepts that may be involved in the embodiments of this application are interpreted below.

Cell measurement initiation criteria:
Taking NR cell reselection as an example (similar to LTE cell reselection criteria), absolute priorities of different NR frequencies or inter-Radio Access Technology (inter-RAT) frequencies may be provided for a terminal via system information or dedicated signaling. The terminal determines whether to initiate measurement based on frequency priorities and the following criteria:

Intra-frequency measurement:
If a serving cell satisfies Srxlev>S_{IntraSearchP} and Squal>S_{IntraSearchQ}, user equipment (UE) may not perform intra-frequency measurement. Otherwise, the UE shall perform intra-frequency measurement.

Inter-frequency and inter-radio access technology (Radio Access Technology, RAT) frequency (inter-RAT frequencies) measurement:
For higher-priority NR inter-frequencies or inter-RAT frequencies, the UE shall always perform measurement.

If a serving cell satisfies Srxlev>S_{nonIntraSearchP} and Squal>S_{nonIntraSearchQ}, the UE may not perform equal-priority or lower-priority NR inter-frequency measurement or lower-priority inter-RAT frequency measurement. Otherwise, the UE shall perform equal-priority or lower-priority NR inter-frequency measurement or lower-priority inter-RAT frequency measurement.

Cell reselection criteria:
NR cell reselection is used as an example (similar to LTE cell reselection criteria).

Intra-frequency and equal-priority inter-frequency cell reselection criteria:
Rₛ=Q_{meas,s}+Q_{hyst}−Qoffsetₜₑₘₚ
Rₙ=Q_{meas,n}−Qoffset−Qoffsetₜₑₘₚ

The terminal sorts cells according to the foregoing R criteria. If a cell is a best cell, the terminal performs cell reselection on the cell.

Inter-frequencies and inter-RAT frequencies cell reselection criteria:
For NR frequency or inter-RAT frequency with a higher priority than the serving frequency (higher priority NR frequency or inter-RAT frequency than the serving frequency):

If threshServingLowQ is broadcasted via system information, and the terminal has been camped on the current serving cell for more than one second, the terminal shall reselect to a cell on an NR frequency or inter-RAT frequency with a higher priority than the current serving frequency if the following condition is satisfied:
Within a time interval Treselection_{RAT}, a cell on a higher-priority NR frequency or EUTRAN RAT/frequency satisfies Squal>Thresh_{X}, _{HighQ}.

Otherwise, the terminal shall reselect to a cell on an NR frequency or inter-RAT frequency with a higher priority than the current serving frequency if the following conditions are satisfied:
Within a time interval Treselection_{RAT}, a cell on a higher-priority RAT/frequency satisfies Srxlev >Thresh_{X, HighP}.
The terminal has been camped on the current serving cell for more than one second.

For NR frequency or inter-RAT frequency with a lower priority than the serving frequency (lower priority NR frequency or inter-RAT frequency than the serving frequency):

If threshServingLowQ is broadcasted via system information, and the terminal has been camped on the current serving cell for more than one second, the terminal shall reselect to a cell on an NR frequency or inter-RAT frequency with a lower priority than the current serving frequency if the following condition is satisfied:
Within a time interval Treselection_{RAT}, a serving cell satisfies Squal<Thresh_{Serving,LowQ} and a lower-priority NR or E-UTRAN RAT/frequency satisfies Squal>Thresh_{X,LowQ}.

Otherwise, the terminal shall reselect to a cell on an NR frequency or inter-RAT frequency with a lower priority than the current serving frequency if the following conditions are satisfied:
Within a time interval Treselection_{RAT}, a serving cell satisfies Srxlev <Thresh_{Serving,LowP} and a lower-priority RAT/frequency cell satisfies Srxlev>Thresh_{X,LowP}.
The terminal has been camped on the current serving cell for more than one second.

If more than one cell satisfies the above conditions, the terminal shall select one cell as follows:
If a highest-priority frequency is an NR frequency, reselection shall be performed to the highest-ranked cell that satisfies the R criteria on the frequency.
If a highest-priority frequency is another RAT frequency, reselection shall be performed to the strongest cell that satisfies the RAT reselection criteria on the frequency.

The foregoing parameters may be interpreted by referring to a related protocol.

In current LTE network deployment, there may be an unauthorized network (“spider” network in which a pseudo base station may be installed), and the network may be configured to enable a terminal to move to a lower-version network, making the terminal susceptible to attacks. For example, the network may move the terminal to a cell under a pseudo base station of a 2^{nd} generation (2G) communication system by setting a priority of a Global System for Mobile Communication (GSM) higher than that of a current serving frequency, or may move the terminal to a cell under a 2G pseudo base station by setting a cell reselection parameter value, thereby exploiting vulnerabilities in the 2G network to initiate attacks against the terminal. For example, by exploiting the terminal's inability to verify an identity of the 2G network, fraudulent or spam messages are sent to victim UE. The advantage of this Short Message Service (SMS) blaster (SMS blaster) attack (from the attacker's perspective) is that any content filtering and SMS sender verification implemented in a real network may be bypassed. As a result, the attacker gains full control over the message content and sender identity, making fraudulent messages more persuasive to the victim and causing losses to the terminal's user. Currently, a network side device cannot prevent the terminal camping on the unauthorized network from performing mobility management based on or in violation of the configuration of the unauthorized network, thus failing to stop the terminal from moving to or accessing an inappropriate network (for example, a lower-version network). Consequently, a risk of a network attack on the terminal cannot be controlled. For the foregoing problem, the embodiments of this application provide a cell reselection method.

With reference to the accompanying drawings, the following describes in detail the cell reselection method provided in the embodiments of this application by using some embodiments and application scenarios thereof.

Referring to FIG. 2, FIG. 2 is a flowchart of a cell reselection method according to an embodiment of this application. The method is applied to a terminal. As shown in FIG. 2, the method includes the following steps:
Step 201: A terminal receives a first indication sent by a network side device.

The first indication is used to instruct at least one of the following:
ignoring or not applying, by the terminal, a first configuration in a cell reselection procedure; or
applying, by the terminal, only a second configuration in the cell reselection procedure.

The first configuration and the second configuration are used in the cell reselection procedure, and the second configuration is different from the first configuration. For example, the first configuration and the second configuration may be frequencies, networks, network parameters, and the like that need to be applied when the terminal performs cell reselection.

In some embodiments, the first configuration may be an inappropriate network configuration, for example, a network version is lower than a configuration of a network that the terminal currently accesses. For example, the first configuration is a 2G network configuration, and the second configuration is a network configuration higher than 2G. The first configuration and the second configuration may be other possible cases, and are not specifically enumerated herein.

In this embodiment of this application, the network side device sends the first indication to the terminal, where the first indication is used to instruct the terminal to ignore or not apply the first configuration, or apply only the second configuration in the cell reselection procedure. Based on the first indication, when performing cell reselection, the terminal may ignore or not apply the first configuration, or apply only the second configuration.

The first indication may be represented by one bit. For example, if a value of the bit is 1/true, it indicates that the terminal is enabled/configured to perform a subsequent target operation; or if the value of the bit is 0/false, it indicates that the terminal is disabled/de-configured from performing the target operation. For another example, if the bit exists and a value of the bit is true, it indicates that the terminal is enabled/configured to perform the target operation.

Step 202: The terminal performs a target operation according to the first indication, where the target operation includes at least one of the following:
ignoring or not applying the first configuration of a target cell in the cell reselection procedure; or
applying only a configuration corresponding to the target cell in the second configuration in the cell reselection procedure.

The target cell is a candidate cell for performing cell reselection by the terminal or a serving cell of the terminal.

In this embodiment of this application, after receiving the first indication sent by the network side device, the terminal performs the target operation according to the first indication. For example, the terminal performs the following target operation according to the first indication: ignoring or not applying the first configuration of the target cell in the cell reselection procedure, or applying only the configuration corresponding to the target cell in the second configuration in the cell reselection procedure.

For example, the first configuration may be a lower-version network configuration, for example, a 2G network configuration. The terminal does not apply this network configuration in the cell reselection procedure, so that the terminal can be prevented from being attacked by applying the lower-version network configuration. In some embodiments, the terminal applies only the second configuration in the cell reselection procedure, and the second configuration is a network configuration other than the first configuration. In this way, the terminal can be prevented from applying the first configuration, so that the terminal is prevented from applying an inappropriate network configuration.

For example, assuming that the first configuration is a frequency, the first configuration configured by the network side device includes three frequencies: a frequency 1, a frequency 2, and a frequency 3, and the candidate cell for the terminal during cell reselection corresponds to the frequency 1, the terminal ignores or does not apply the frequency 1 corresponding to the candidate cell in the cell reselection procedure, to prevent the terminal from accessing the frequency 1. For another example, assuming that the second configuration is also a frequency, the second configuration configured by the network side device includes a frequency 4 and a frequency 5, and the candidate cell for the terminal during cell reselection corresponds to the frequency 5, the terminal applies the frequency 5 in the second configuration in the cell reselection procedure, so that the terminal accesses the cell corresponding to the frequency 5.

In this embodiment of this application, a terminal receives a first indication sent by a network side device, and performs the following target operation according to the first indication: ignoring or not applying a first configuration of a target cell in a cell reselection procedure, or applying only a configuration corresponding to the target cell in the second configuration in the cell reselection procedure. In this way, the network side device configures behavior of the terminal in the cell reselection procedure, so that the terminal can perform the target operation in the cell reselection procedure according to the configuration of the network side device, the operation behavior of the terminal is more controllable, and the network side device can learn the operation behavior of the terminal in the cell reselection procedure. This helps the network side device make timely adjustment when the terminal accesses an inappropriate network, so that the terminal is prevented from suffering a network attack, and a risk of the network attack on the terminal is more controllable.

In some embodiments, the first indication is carried in a target configuration, and the performing, by the terminal, a target operation according to the first indication includes:
performing, by the terminal, the target operation according to the target configuration.

That is, the terminal receives the target configuration sent by the network side device, where the target configuration carries the first indication, and the terminal further performs the target operation according to the target configuration.

In some embodiments, the target configuration further includes a target value, and in a case that the terminal ignores or does not apply the first configuration in the cell reselection procedure, a value of the configuration that is of the target cell and to be applied by the terminal is the target value. It can be understood that the network side device instructs the terminal to ignore or not apply the first configuration in the cell reselection procedure, and may further indicate, to the terminal via the target value, a value of a cell configuration that can be applied by the terminal, so that the terminal can apply the target value in the cell reselection procedure to perform mobility management, and the network side device can control the cell reselection behavior of the terminal.

In some embodiments, the target configuration further includes a first area configuration, and the first area configuration is used for indicating the terminal to perform the target operation within a first area. Further, the network side device can also indicate, via the first area configuration, an area/a range in which the terminal performs the target operation, so that the cell reselection procedure of the terminal is more controllable.

In some embodiments, the first area configuration includes at least one of the following:
at least one Tracking Area Identifier (TAI), including a Public Land Mobile Network (PLMN) identifier (ID), an International Mobile Equipment Identity (IMEI) type allocation code (IMEI Type Allocation Code, TAC), and the like;
at least one Cell Global Identifier (CGI), including a PLMN ID, a cell identifier (cell ID), and the like;
at least one frequency and Physical Cell Identifier (PCI) list;
at least one geographical area, where for example, one geographical area may be identified by one reference point (represented by one geographic coordinate) and one distance threshold, or may be identified by a plurality of geographic coordinates; or
at least one radio access network RAN area (identified by a RAN area ID identifier), including a TAC and a RAN area code.

In some embodiments, the target configuration further includes a first time for indicating the terminal to perform the target operation within the first time. Further, the network side device can further indicate, via the first time, a time range in which the terminal performs the target operation, so that the network side device can learn a time or a time period in which the terminal performs the target operation, and the cell reselection behavior of the terminal is more controllable.

In some embodiments, the first time is represented by at least one of the following:
a timer, where for example, the terminal may perform the target operation during running of the timer; or
a time window, where for example, the terminal may perform the target operation within a window range of the time window.

In some embodiments, in a case that the first time is represented by the timer, the first time is determined based on at least one of a length of the timer or a start point of the timer.

In some embodiments, in a case that the first time is represented by the timer, the performing, by the terminal, the target operation according to the target configuration includes any one of the following:
starting, by the terminal, the timer at the start point of the timer in a case that the first time is determined based on at least the start point of the timer, and performing the target operation according to the target configuration during running of the timer in a case that the terminal is in idle state (idle) or inactive state (inactive);
in a case that the first time is determined based on the length of the timer, starting, by the terminal, the timer when entering idle state or inactive state, and performing the target operation according to the target configuration in a case that the timer runs; or
in a case that the first time is determined based on the length of the timer, starting, by the terminal, the timer when receiving the target configuration, and performing the target operation according to the target configuration in a case that the timer runs and the terminal is in idle state or inactive state.

For example, the terminal receives, in a connected state, the target configuration sent by the network side device, where the target configuration includes the first time, and the first time is represented by the timer. In an implementation, if the terminal starts the timer at the start point of the timer, the timer starts to run, and the terminal performs the target operation according to the target configuration during running of the timer in a case that the terminal is in idle state or inactive state, for example, ignoring or not applying the first configuration, or applying only the second configuration. If the timer expires, the terminal cancels execution of the target operation.

In another implementation, when the terminal enters idle state or inactive state, the timer is started, and the terminal performs the target operation during running of the timer. If the timer expires, the terminal cancels execution of the target operation.

In another implementation, the terminal starts the timer when receiving the target configuration sent by the network side device, and performs the target operation during running of the timer when the terminal is in idle state or inactive state. If the timer expires, the terminal cancels execution of the target operation.

In this way, it is defined that the terminal performs the target operation during running of the timer in a case that the terminal enters idle state or inactive state, so that the behavior of the terminal is more controllable.

In some embodiments, in a case that the first time is represented by the time window, the first time includes any one of the following:
a length of the time window, where a time at which the terminal enters idle state or inactive state is a start point of the time window;
a start point and a length of the time window; or
a start point and an end point of the time window.

Through the configuration of the time window, the terminal can thus be controlled regarding when and for how long it should perform the target operation, to better control the cell reselection behavior of the terminal.

In some embodiments, in a case that the first time is determined based on the length of the time window, the terminal considers that the time at which the terminal enters idle state or inactive state is the start point of the time window.

In some embodiments, in a case that the first time is determined based on the length of the time window, the terminal considers that a time at which the target configuration is received is the start point of the time window.

In this embodiment of this application, the receiving, by a terminal, a target configuration sent by a network side device includes at least one of the following:
receiving, by the terminal via a Radio Resource Control (RRC) message, the target configuration sent by the network side device, where the RRC message includes the target configuration;
receiving, by the terminal via a Non-Access Stratum (NAS) message, the target configuration sent by the network side device, where the NAS message includes the target configuration; or
receiving, by the terminal in idle state or inactive state via a first message, the target configuration sent by the network side device, where the first message includes the target configuration.

For example, the terminal may receive the target configuration from a base station via an RRC release message. In some embodiments, the terminal receives the target configuration from a core network device (for example, a Mobility Management Entity (MME)) via the NAS message, for example, an attach accept message. In some embodiments, the terminal may receive the target configuration via the first message sent by a core network device or a base station, where the first message carries the target configuration. For example, the first message may be a paging message, a core network (CN) paging message, or a RAN paging message. In this way, the network side device can send the target configuration in a plurality of manners, thereby enriching a transmission manner of the target configuration.

In some embodiments, the receiving, by the terminal via a non-access stratum NAS message, the target configuration sent by the network side device includes:
receiving, by NAS of the terminal, the NAS message sent by a core network device, and indicating or delivering, by the NAS of the terminal, the target configuration to an access stratum (AS) of the terminal.

In other words, if the NAS of the terminal receives the target configuration, the NAS forwards the target configuration to the AS, so that the terminal performs the target operation based on the AS, for example, applies the second configuration in the cell reselection procedure to access the network.

In some embodiments, the first message is sent by the core network device, and the core network device is further configured to send a second message to the base station, where the second message includes the target configuration and/or a third indication, and the third indication is used to indicate that the core network device has sent the target configuration to the terminal. In this way, the base station can be prevented from resending the target configuration to the terminal, so that unnecessary and repeated sending behavior is avoided, or both the base station and the core network can know that the terminal is configured with the target configuration.

In some embodiments, the RRC message, the NAS message, and the first message are ciphered and/or integrity-protected messages. In this way, security of the target configuration can be effectively ensured.

In this embodiment of this application, the target configuration sent by the network side device to the terminal further includes a second indication, the second indication is used for content of the first configuration, and the content of the first configuration includes at least one of the following:
a first network, where for example, the first network includes at least one of the following: NR, Evolved Universal Terrestrial Radio Access (E-UTRA), Universal Terrestrial Radio Access (UTRA), a Global System for Mobile Communication (GSM) or an Enhanced Data Rate for GSM Evolution (EDGE) radio access network (GSM/EDGE Radio Access Network, GERAN), or Code Division Multiple Access2000 (CDMA2000);
a first frequency, where the first frequency may be one or more frequencies configured by the network side device; or
a first parameter, where the first parameter is an inter-frequency or inter-RAT cell reselection parameter.

Inter-frequency refers to a frequency that is different from a service frequency of the terminal. Inter-system refers to a system that is different from a system to which a serving cell of the terminal belongs.

In a case that the target configuration includes the second indication, and the second indication indicates the content of the first configuration, the terminal performs the target behavior based on the target configuration. For example, if the content that is of the first configuration and indicated by the second indication in the target configuration includes the first frequency, that is, if the network side device indicates one or more frequencies, the terminal ignores or does not apply the one or more frequencies indicated by the network side device when performing cell reselection. The network side device may further indicate the first network and/or the first parameter, and the terminal ignores or does not apply the first network and/or the first parameter based on the indication of the network side device. This is not specifically enumerated herein.

Content of the first configuration includes at least one of the following:
a first network;
a first frequency; or
a first parameter, where
the first network, the first frequency, or the first parameter is preconfigured or is specified in a protocol.

In other words, the first network, the first frequency, or the first parameter is not configured by the network side device, but is preconfigured or is specified in the protocol. In this implementation, the target configuration does not include the second indication, and the terminal does not need to perform the target behavior according to the target configuration. When performing cell reselection, the terminal may ignore or not apply the first network, the first frequency, or the first parameter that is preconfigured or is specified in the protocol.

In some embodiments, the first parameter includes at least one of the following:
a minimum required receive level in the cell (for example, Qᵣₓₗₑᵥₘᵢₙ);
a minimum required signal quality value in the cell (for example, Q_{qualmin});
a first threshold (for example, Thresh_{X,HighQ}), where the first threshold is a cell selection signal quality threshold used by the terminal when performing cell reselection to a higher-priority RAT or frequency;
a second threshold (for example, Thresh_{X,HighP}), where the second threshold is a cell selection RX level value threshold used by the terminal when performing cell reselection to a higher-priority RAT or frequency;
a third threshold (for example, Thresh_{X,LowP}), where the third threshold is a cell selection RX level value threshold used by the terminal when performing cell reselection to a lower-priority RAT or frequency;
a fourth threshold (for example, Thresh_{X,LowQ}), where the fourth threshold is a cell selection quality threshold used by the terminal when performing cell reselection to a lower-priority RAT or frequency;
a fifth threshold (for example, Thresh_{Serving,LowP}), where the fifth threshold is a cell selection quality threshold used by the terminal for a serving cell when performing cell reselection to a lower-priority RAT or frequency; or
a sixth threshold (for example, Thresh_{Serving,LowQ}), where the sixth threshold is a cell selection quality threshold used by the terminal for a serving cell when performing cell reselection to a lower-priority RAT or frequency.

In some embodiments, in a case that the content of the first configuration includes the first parameter, that is, the target configuration includes the first parameter, or the first parameter is preconfigured or is specified in the protocol, the performing, by the terminal, a target operation includes at least one of the following:
a1. ignoring or not applying, by the terminal, the minimum receive level value required by the target cell, where the minimum receive level value required by the target cell is provided by the target cell;
a2. ignoring or not applying, by the terminal, the minimum signal quality value required by the target cell, where the minimum signal quality value required by the target cell is provided by the target cell;
a3. in a case that the minimum receive level value required by the target cell is configured to be greater than or equal to a first value, ignoring or not applying, by the terminal, the minimum receive level value required by the target cell;
a4. in a case that the minimum signal quality value required by the target cell is configured to be greater than or equal to a second value, ignoring or not applying, by the terminal, the minimum signal quality value required by the target cell;
a5. ignoring or not applying, by the terminal, the first threshold;
a6. ignoring or not applying, by the terminal, the second threshold;
a7. ignoring or not applying, by the terminal, the third threshold;
a8. ignoring or not applying, by the terminal, the fourth threshold;
a9. ignoring or not applying, by the terminal, the fifth threshold;
a10. ignoring or not applying, by the terminal, the sixth threshold;
a11. in a case that the first threshold is configured to be less than or equal to a third value, ignoring or not applying, by the terminal, the first threshold;
a12. in a case that the second threshold is configured to be less than or equal to a fourth value, ignoring or not applying, by the terminal, the second threshold;
a13. in a case that the third threshold is configured to be less than or equal to a fifth value, ignoring or not applying, by the terminal, the third threshold;
a14. in a case that the fourth threshold is configured to be less than or equal to a sixth value, ignoring or not applying, by the terminal, the fourth threshold;
a15. in a case that the fifth threshold is configured to be greater than or equal to a seventh value, ignoring or not applying, by the terminal, the fifth threshold; or
a16. in a case that the sixth threshold is configured to be greater than or equal to an eighth value, ignoring or not applying, by the terminal, the sixth threshold.

The first value, the second value, the third value, the fourth value, the fifth value, the sixth value, the seventh value, and the eighth value may be values specified in the protocol or configured on the network side. If the foregoing values are configured on the network side, the foregoing values may be included in the target configuration.

In this embodiment of this application, the terminal ignores or does not apply the first parameter in the cell reselection procedure according to the configuration of the first parameter, for example, ignores the minimum receive level value required by the serving cell of the terminal, or ignores the minimum signal quality value required by the serving cell of the terminal, or ignores the cell selection signal quality threshold used by the terminal when performing cell reselection to a higher-priority RAT or frequency. This is not listed one by one herein.

In some embodiments, the method further includes at least one of the following:
b1. In a case that the terminal ignores or does not apply the minimum receive level value required by the target cell, considering, by the terminal, the minimum receive level value required by the target cell as a first target value, where the first target value is the same as or different from the first value. For example, the first target value is −116 dBm. Specially, the first target value may be negative infinity. In some embodiments, the terminal may obtain, via a System Information Block 1 (SIB1) of the target cell, the minimum receive level value required by the target cell. For example, if the target cell is a cell of a pseudo base station, the pseudo base station may configure the minimum receive level value required by the target cell to be sufficiently large (negative), so that a calculation result of a cell selection receive level value Srxlev/cell selection quality value Squal of the target cell is sufficiently small, causing the terminal to possibly access the target cell. In this embodiment of this application, the terminal considers the minimum receive level value required by the target cell as the first value, and the terminal ignores the first value, so that the terminal can avoid accessing the target cell and thereby avoid accessing the pseudo base station, preventing the terminal from suffering a network attack.
b2. In a case that the terminal ignores or does not apply the minimum signal quality value required by the target cell, considering, by the terminal, the minimum signal quality value required by the target cell as a second target value, where the second target value is the same as or different from the second value. Specially, the second target value may be negative infinity. In some embodiments, the terminal obtains, via a SIB1, the minimum signal quality value required by the target cell. For example, the terminal considers the minimum signal quality value required by the target cell as the second value, and the terminal ignores the second value, to prevent the terminal from suffering a network attack when accessing the target cell.
b3. In a case that the terminal ignores or does not apply the first threshold, considering, by the terminal, the first threshold as a third target value, where the third target value is the same as or different from the third value.
b4. In a case that the terminal ignores or does not apply the second threshold, considering, by the terminal, the second threshold as a fourth target value, where the fourth target value is the same as or different from the fourth value.
b5. In a case that the terminal ignores or does not apply the third threshold, considering, by the terminal, the third threshold as a fifth target value, where the fifth target value is the same as or different from the fifth value.
b6. In a case that the terminal ignores or does not apply the fourth threshold, considering, by the terminal, the fourth threshold as a sixth target value, where the sixth target value is the same as or different from the sixth value.
b7. In a case that the terminal ignores or does not apply the fifth threshold, considering, by the terminal, the fifth threshold as a seventh target value, where the seventh target value is the same as or different from the seventh value.
b8. In a case that the terminal ignores or does not apply the sixth threshold, considering, by the terminal, the sixth threshold as an eighth target value, where the eighth target value is the same as or different from the eighth value.

It should be noted that the terminal may obtain the first threshold, the second threshold, the third threshold, the fourth threshold, the fifth threshold, and the sixth threshold via other system information (Other SIB) of the target cell. For example, taking the first threshold as an example, the first threshold is a cell selection signal quality threshold used by the terminal when performing cell reselection to a higher-priority RAT or frequency. The pseudo base station may set the first threshold to be sufficiently small, so that a neighboring cell (the cell of the pseudo base station) can more easily meet the cell selection signal quality value used by the terminal when performing cell reselection, causing the terminal to possibly access the neighboring cell. In this embodiment of this application, the terminal ignores the first threshold, so that the terminal can effectively avoid accessing the cell of the pseudo base station, preventing the terminal from suffering a network attack. It can be understood that a case that the terminal ignores other thresholds can also be handled by referring to the example of the first threshold mentioned above, and no further details are provided herein.

In some embodiments, the first target value, the second target value, the third target value, the fourth target value, the fifth target value, the sixth target value, the seventh target value, and the eighth target value may be values specified in the protocol or configured on the network side. If the foregoing values are configured on the network side, the foregoing values may be included in the target configuration.

In some embodiments, the first parameter is a parameter corresponding to a frequency of the first network or a parameter corresponding to the first frequency. For example, the first parameter includes the first threshold, the second threshold, the third threshold, or the fourth threshold. These thresholds are provided on a per-frequency basis. In a case that the terminal ignores the first parameter, a parameter corresponding to a frequency (for example, the first frequency or the frequency of the first network) indicated by the first configuration is ignored.

In this embodiment of this application, in a case that the content of the first configuration includes the first network, that is, the target configuration includes the first network, or the first network is preconfigured or is specified in the protocol, the performing, by the terminal, a target operation may include at least one of the following:
ignoring or not applying, by the terminal, the first network;
ignoring or not applying, by the terminal, a frequency of the first network; or
ignoring or not applying, by the terminal, a priority that is of the frequency of the first network and configured by a first cell, where the first cell is a serving cell of the terminal.

In this embodiment of this application, the target configuration includes the first indication, and the first indication is used to instruct the terminal to ignore or not apply the first configuration in the cell reselection procedure. If the content of the first configuration includes the first network, in the cell reselection procedure, the terminal may ignore the first network, or ignore the frequency of the first network, or ignore or not apply the priority that is of the frequency of the first network and configured by the serving cell of the terminal. In this way, the terminal does not perform cell reselection evaluation on the first network or the frequency of the first network, thereby preventing the terminal from accessing the first network. This helps avoid the terminal accessing an inappropriate network and suffering a network attack, thus ensuring terminal security.

It should be noted that the ignoring or not applying the first network or the ignoring or not applying the frequency of the first network is not starting measurement on the frequency of the first network. For example, if the frequency of the first network includes f1 and f2, the terminal does not measure f1 and f2.

The first network may be specified in the protocol or configured on the network side.

In some embodiments, the ignoring or not applying, by the terminal in the cell reselection procedure, a priority that is of the frequency of the first network and configured by a first cell includes at least one of the following:
determining, by the terminal, the frequency of the first network as a lowest-priority frequency;
determining, by the terminal, a value of the priority of the frequency of the first network as a ninth value; or
considering, by the terminal, that the priority of the frequency of the first network is not provided.

For example, the terminal determines the frequency of the first network as the lowest-priority frequency, that is, the priority of the frequency of the first network is lower than any value of a frequency priority configured by the network. Therefore, in the cell reselection procedure, the terminal does not give priority to the frequency of the first network, thereby effectively avoiding the terminal accessing the first network.

In some embodiments, the terminal determines the value of the priority of the frequency of the first network as the ninth value, where the ninth value is specified in the protocol or configured on the network side. For example, the ninth value is a relatively low value, and therefore the priority of the frequency of the first network is relatively low. In the cell reselection procedure, the terminal does not consider the frequency of the first network, to avoid the terminal accessing the first network.

In some embodiments, the terminal considers that the priority of the frequency of the first network is not provided, and the terminal does not perform measurement and/or cell reselection evaluation on a frequency whose priority is not provided. Therefore, the terminal does not perform cell reselection evaluation on the frequency of the first network, thereby effectively avoiding the terminal accessing the first network.

In some embodiments, the ignoring or not applying, by the terminal, the first configuration of a target cell in the cell reselection procedure includes:
in a case that the priority of the frequency of the first network is greater than or equal to a seventh threshold, ignoring or not applying, by the terminal, the first configuration of the target cell in the cell reselection procedure.

The seventh threshold is specified in the protocol or configured on the network side. In this embodiment of this application, if the priority of the frequency of the first network is greater than or equal to the seventh threshold, the terminal ignores or does not apply the first configuration of the target cell in the cell reselection procedure, for example, ignores or does not apply the priority of the frequency of the first network.

In this embodiment of this application, in a case that the target configuration includes the first frequency, or the first frequency is preconfigured or is specified in the protocol, the performing, by the terminal, a target operation includes at least one of the following:
ignoring or not applying, by the terminal, the first frequency; or
ignoring or not applying, by the terminal, a priority that is of the first frequency and configured by a first cell.

In this embodiment of this application, the target configuration includes the first indication, and the first indication is used to instruct the terminal to ignore or not apply the first configuration in the cell reselection procedure. If the content of the first configuration includes the first frequency, the terminal may ignore the first frequency in the cell reselection procedure, or ignore or not apply the priority that is of the first frequency and configured by a serving cell or a cell reselection candidate cell of the terminal. In this way, the terminal does not perform measurement and/or cell reselection evaluation on the first frequency, to prevent the terminal from accessing the network deployed at the first frequency. This helps avoid the terminal accessing an inappropriate network and suffering a network attack.

In some embodiments, the ignoring or not applying, by the terminal, a priority that is of the first frequency and configured by a first cell includes at least one of the following:

Determining, by the terminal, the first frequency as a lowest-priority frequency, that is, lower than any value configured by the network. In this way, the terminal does not consider the first frequency in the cell reselection procedure, thereby effectively avoiding the terminal accessing the first frequency.

Determining, by the terminal, a value of the priority of the first frequency as a tenth value, where the tenth value is specified in the protocol or configured on the network side. For example, the tenth value is a relatively low value, and therefore the priority of the first frequency is relatively low, and is not considered by the terminal, thereby effectively avoiding the terminal accessing the first frequency.

Deeming, by the terminal, that the priority of the first frequency is not provided. It can be understood that the terminal does not perform measurement and/or cell reselection evaluation on a frequency whose priority is not provided, and therefore the terminal does not perform cell reselection evaluation on the priority of the first frequency, thereby avoiding the terminal accessing the first frequency.

In some embodiments, the ignoring or not applying, by the terminal, the first configuration of a target cell in the cell reselection procedure includes:
in a case that the priority of the at least one first frequency is greater than or equal to an eighth threshold, ignoring or not applying, by the terminal, the first configuration of the target cell in the cell reselection procedure.

The eighth threshold is specified in the protocol or configured on the network side. In this embodiment of this application, if the priority of the at least one first frequency is greater than or equal to the eighth threshold, the terminal ignores or does not apply the first configuration of the target cell in the cell reselection procedure, for example, ignores or does not apply the priority of the first frequency, to avoid the terminal accessing the first frequency.

In this embodiment of this application, a network side device configures behavior of a terminal in a cell reselection procedure, so that the terminal can perform a target operation in the cell reselection procedure according to the configuration of the network side device, and the operation behavior of the terminal is more controllable.

Referring to FIG. 3, FIG. 3 is a flowchart of another cell reselection method according to an embodiment of this application. The method is applied to a network side device. As shown in FIG. 3, the method includes the following steps:
Step 301: A network side device sends a first indication to a terminal, where the first indication is used to instruct at least one of the following: ignoring or not applying, by the terminal, a first configuration in a cell reselection procedure, or applying, by the terminal, only a second configuration in the cell reselection procedure.

The first configuration and the second configuration are used in the cell reselection procedure, and the second configuration is different from the first configuration.

In some embodiments, the sending, by a network side device, a first indication to a terminal includes:
sending, by the network side device, a target configuration to the terminal, where the target configuration carries the first indication.

In some embodiments, the target configuration further includes a second indication, the second indication is used to indicate content of the first configuration, and the content of the first configuration includes at least one of the following:
a first network;
a first frequency; or
a first parameter.

In some embodiments, the first parameter is an inter-frequency or inter-RAT cell reselection parameter, and the first parameter includes at least one of the following:
a minimum required receive level in the cell;
a minimum required signal quality value in the cell;
a first threshold, where the first threshold is a cell selection signal quality threshold used by the terminal when performing cell reselection to a higher-priority RAT or frequency;
a second threshold, where the second threshold is a cell selection RX level value threshold used by the terminal when performing cell reselection to a higher-priority RAT or frequency;
a third threshold, where the third threshold is a cell selection RX level value threshold used by the terminal when performing cell reselection to a lower-priority RAT or frequency;
a fourth threshold, where the fourth threshold is a cell selection quality threshold used by the terminal when performing cell reselection to a lower-priority RAT or frequency;
a fifth threshold, where the fifth threshold is a cell selection quality threshold used by the terminal for a serving cell when performing cell reselection to a lower-priority RAT or frequency; or
a sixth threshold, where the sixth threshold is a cell selection quality threshold used by the terminal for a serving cell when performing cell reselection to a lower-priority RAT or frequency.

In some embodiments, the target configuration further includes a target value, and in a case that the terminal ignores or does not apply the first configuration in the cell reselection procedure, a value of the first configuration that is of the target cell and to be applied by the terminal is the target value.

In some embodiments, the target configuration further includes a first area configuration, and the first area configuration is used for indicating the terminal to perform the target operation within a first area.

In some embodiments, the first area configuration includes at least one of the following:
at least one tracking area identifier TAI;
at least one cell global identifier CGI;
at least one frequency and physical cell identifier PCI list;
at least one geographical area; or
at least one radio access network RAN area.

In some embodiments, the target configuration further includes a first time for indicating the terminal to perform the target operation within the first time.

In some embodiments, the first time is represented by at least one of the following:
a timer; or
a time window.

In some embodiments, in a case that the first time is represented by the timer, the first time is determined based on at least one of a length of the timer or a start point of the timer.

In some embodiments, in a case that the first time is represented by the time window the first time is determined based on any one of the following:
a length of the time window;
a start point and a length of the time window; or
a start point and an end point of the time window.

In some embodiments, the sending, by a network side device, a target configuration to a terminal includes any one of the following:
sending, by the network side device, the target configuration to the terminal via an RRC message, where the RRC message includes the target configuration;
sending, by the network side device, the target configuration to the terminal via a NAS message, where the NAS message includes the target configuration; or
sending, by the network side device, the target configuration to the terminal via a first message, where the first message includes the target configuration.

In some embodiments, the network side device is a core network device, and after the sending, by the network side device, the target configuration to the terminal via a first message, the method further includes:
sending, by the core network device, a second message to a base station, where the second message includes at least one of the following:
the target configuration; or
a third indication, where the third indication is used to instruct the core network device to send the target configuration to the terminal.

The cell reselection method provided in this embodiment of this application is applied to the network side device and corresponds to the foregoing method embodiment applied to the terminal side. For a related concept and a specific implementation procedure in this embodiment of this application, reference may be made to the descriptions in the foregoing method embodiment on the terminal side. Details are not described herein again.

In this embodiment of this application, a network side device configures behavior of a terminal in a cell reselection procedure, so that the terminal can perform a target operation in the cell reselection procedure according to the configuration of the network side device, the operation behavior of the terminal is more controllable, and the network side device can learn the operation behavior of the terminal in the cell reselection procedure. This helps the network side device make timely adjustment when the terminal accesses an inappropriate network, so that the terminal is prevented from suffering a network attack, and a risk of the network attack on the terminal is more controllable.

The cell reselection method provided in the embodiments of this application can be performed by a cell reselection apparatus. In the embodiments of this application, an example in which the cell reselection apparatus performs the cell reselection method is used to describe the cell reselection apparatus provided in the embodiments of this application.

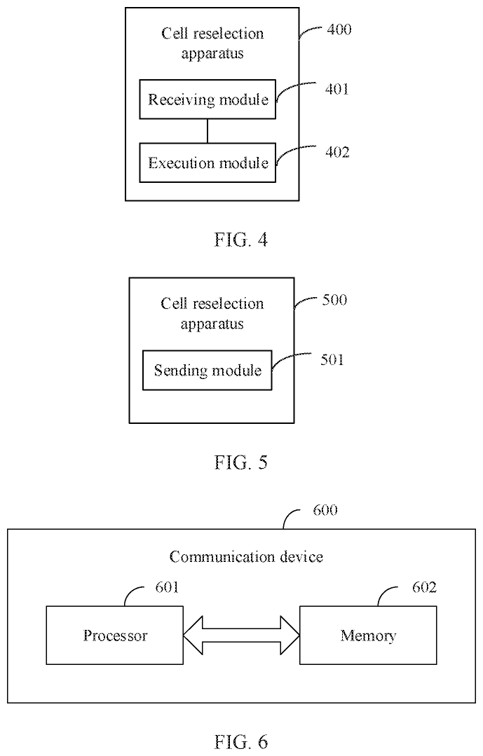

Referring to FIG. 4, FIG. 4 is a structural diagram of a cell reselection apparatus according to an embodiment of this application, and the apparatus is applied to a terminal. As shown in FIG. 4, the cell reselection apparatus 400 includes:
a receiving module 401, configured to receive a first indication sent by a network side device, where the first indication is used to instruct at least one of the following: ignoring or not applying, by the terminal, a first configuration in a cell reselection procedure, or applying, by the terminal, only a second configuration in the cell reselection procedure; and
an execution module 402, configured to perform a target operation according to the first indication, where the target operation includes at least one of the following:
ignoring or not applying the first configuration of a target cell in the cell reselection procedure; or
applying only a configuration corresponding to the target cell in the second configuration in the cell reselection procedure, where
the target cell is a candidate cell for performing cell reselection by the terminal or a serving cell of the terminal, the first configuration and the second configuration are used in the cell reselection procedure, and the second configuration is different from the first configuration.

In some embodiments, the first indication is carried in a target configuration, and the execution module 402 is configured to:
perform the target operation according to the target configuration.

In some embodiments, the target configuration further includes a second indication, the second indication is used to indicate content of the first configuration, and the content of the first configuration includes at least one of the following:
a first network;
a first frequency; or
a first parameter.

In some embodiments, content of the first configuration includes at least one of the following:
a first network;
a first frequency; or
a first parameter, where
the first network, the first frequency, or the first parameter is preconfigured or is specified in a protocol.

In some embodiments, the first parameter is an inter-frequency or inter-RAT cell reselection parameter, and the first parameter includes at least one of the following:
a minimum required receive level in the cell;
a minimum required signal quality value in the cell;
a first threshold, where the first threshold is a cell selection signal quality threshold used by the terminal when performing cell reselection to a higher-priority RAT or frequency;
a second threshold, where the second threshold is a cell selection RX level value threshold used by the terminal when performing cell reselection to a higher-priority RAT or frequency;
a third threshold, where the third threshold is a cell selection RX level value threshold used by the terminal when performing cell reselection to a lower-priority RAT or frequency;
a fourth threshold, where the fourth threshold is a cell selection quality threshold used by the terminal when performing cell reselection to a lower-priority RAT or frequency;
a fifth threshold, where the fifth threshold is a cell selection quality threshold used by the terminal for a serving cell when performing cell reselection to a lower-priority RAT or frequency; or
a sixth threshold, where the sixth threshold is a cell selection quality threshold used by the terminal for a serving cell when performing cell reselection to a lower-priority RAT or frequency.

In some embodiments, in a case that the target configuration includes the first parameter, or the first parameter is preconfigured or is specified in the protocol, the execution module 402 is configured to perform at least one of the following:
ignoring or not applying the minimum receive level value required by the target cell;
ignoring or not applying the minimum signal quality value required by the target cell;
in a case that the minimum receive level value required by the target cell is configured to be greater than or equal to a first value, ignoring or not applying the minimum receive level value required by the target cell;
in a case that the minimum signal quality value required by the target cell is configured to be greater than or equal to a second value, ignoring the minimum signal quality value required by the target cell;
ignoring or not applying the first threshold;
ignoring or not applying the second threshold;
ignoring or not applying the third threshold;
ignoring or not applying the fourth threshold;
ignoring or not applying the fifth threshold;
ignoring or not applying the sixth threshold;
in a case that the first threshold is configured to be less than or equal to a third value, ignoring or not applying the first threshold;
in a case that the second threshold is configured to be less than or equal to a fourth value, ignoring or not applying the second threshold;
in a case that the third threshold is configured to be less than or equal to a fifth value, ignoring or not applying the third threshold;
in a case that the fourth threshold is configured to be less than or equal to a sixth value, ignoring or not applying the fourth threshold;
in a case that the fifth threshold is configured to be greater than or equal to a seventh value, ignoring or not applying the fifth threshold; or
in a case that the sixth threshold is configured to be greater than or equal to an eighth value, ignoring or not applying the sixth threshold.

In some embodiments, the execution module 402 is further configured to perform at least one of the following:
in a case that the terminal ignores or does not apply the minimum receive level value required by the target cell, considering the minimum receive level value required by the target cell as a first target value;
in a case that the terminal ignores or does not apply the minimum signal quality value required by the target cell, considering the minimum signal quality value required by the target cell as a second target value;
in a case that the terminal ignores or does not apply the first threshold, considering the first threshold as a third target value;
in a case that the terminal ignores or does not apply the second threshold, considering the second threshold as a fourth target value;
in a case that the terminal ignores or does not apply the third threshold, considering the third threshold as a fifth target value;
in a case that the terminal ignores or does not apply the fourth threshold, considering the fourth threshold as a sixth target value;
in a case that the terminal ignores or does not apply the fifth threshold, considering the fifth threshold as a seventh target value; or
in a case that the terminal ignores or does not apply the sixth threshold, considering the sixth threshold as an eighth target value.

In some embodiments, the first parameter is a parameter corresponding to a frequency of the first network or a parameter corresponding to the first frequency.

In some embodiments, in a case that the target configuration includes the first network, or the first network is preconfigured or is specified in the protocol, the execution module 402 is further configured to perform at least one of the following:
ignoring or not applying the first network
ignoring or not applying a frequency of the first network; or
ignoring or not applying a priority that is of the frequency of the first network and configured by a first cell, where the first cell is a serving cell of the terminal.

In some embodiments, the execution module 402 is further configured to perform at least one of the following:
determining the frequency of the first network as a lowest-priority frequency;
determining a value of the priority of the frequency of the first network as a ninth value; or
considering that the priority of the frequency of the first network is not provided.

In some embodiments, the execution module 402 is further configured to:
in a case that the priority of the frequency of the first network is greater than or equal to a seventh threshold, ignore or not apply the first configuration of the target cell in the cell reselection procedure.

In some embodiments, in a case that the target configuration includes the first frequency, or the first frequency is preconfigured or is specified in the protocol, the execution module 402 is further configured to perform at least one of the following:
ignoring or not applying the first frequency; or
ignoring or not applying a priority that is of the first frequency and configured by a first cell, where the first cell is a serving cell of the terminal.

In some embodiments, the execution module 402 is further configured to perform at least one of the following:
determining the first frequency as a lowest-priority frequency;
determining a value of the priority of the first frequency as a tenth value; or
considering that the priority of the first frequency is not provided.

In some embodiments, the execution module 402 is further configured to:
in a case that the priority of the at least one first frequency is greater than or equal to an eighth threshold, ignore or not apply the first configuration of the target cell in the cell reselection procedure.

In some embodiments, the target configuration further includes a target value, and in a case that the terminal ignores or does not apply the first configuration in the cell reselection procedure, a value of the first configuration that is of the target cell and to be applied by the terminal is the target value.

In some embodiments, the target configuration further includes a first area configuration, and the first area configuration is used for indicating the terminal to perform the target operation within a first area.

In some embodiments, the first area configuration includes at least one of the following:
at least one tracking area identifier TAI;
at least one cell global identifier CGI;
at least one frequency and physical cell identifier PCI list;
at least one geographical area; or
at least one radio access network RAN area.

In some embodiments, the target configuration further includes a first time for indicating the terminal to perform the target operation within the first time.

In some embodiments, the first time is represented by at least one of the following:
a timer; or
a time window.

In some embodiments, in a case that the first time is represented by the timer, the first time is determined based on at least one of a length of the timer or a start point of the timer.

In some embodiments, the execution module 402 is further configured to perform any one of the following:
starting the timer at the start point of the timer in a case that the first time is determined based on at least the start point of the timer, and performing the target operation according to the target configuration during running of the timer in a case that the terminal is in idle state or inactive state;
in a case that the first time is determined based on the length of the timer, starting the timer when entering idle state or inactive state, and performing the target operation according to the target configuration in a case that the timer runs; or
in a case that the first time is determined based on the length of the timer, starting the timer when receiving the target configuration, and performing the target operation according to the target configuration in a case that the timer runs and the terminal is in idle state or inactive state.

In some embodiments, in a case that the first time is represented by the time window the first time is determined based on any one of the following:
a length of the time window;
a start point and a length of the time window; or
a start point and an end point of the time window.

In some embodiments, in a case that the first time is determined based on the length of the time window, the terminal considers that a time at which the terminal enters idle state or inactive state is the start point of the time window; or the terminal considers that a time at which the target configuration is received is the start point of the time window.

In some embodiments, the receiving module 401 is further configured to:
receive, via a radio resource control RRC message, the target configuration sent by the network side device, where the RRC message includes the target configuration;
receive, via a non-access stratum NAS message, the target configuration sent by the network side device, where the NAS message includes the target configuration; or
receive, in idle state or inactive state via a first message, the target configuration sent by the network side device, where the first message includes the target configuration.

In some embodiments, the receiving module 401 is configured to:
receive the NAS message sent by a core network device, and indicate, by the NAS of the terminal, the target configuration to AS of the terminal.

In some embodiments, the RRC message, the NAS message, and the first message are ciphered and/or integrity-protected messages.

In this embodiment of this application, a network side device configures behavior of a terminal in a cell reselection procedure, so that the terminal can perform a target operation in the cell reselection procedure according to the configuration of the network side device, the operation behavior of the terminal is more controllable, and the network side device can learn the operation behavior of the terminal in the cell reselection procedure. This helps the network side device make timely adjustment when the terminal accesses an inappropriate network, so that the terminal is prevented from suffering a network attack, and a risk of the network attack on the terminal is more controllable.

The cell reselection apparatus 400 in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed type of the terminal 11. The another device may be a server, a Network Attached Storage (NAS), or the like. This is not specifically limited in this embodiment of this application.

The cell reselection apparatus 400 provided in this embodiment of this application can implement the processes implemented in the method embodiment in FIG. 2, and achieve a same technical effect. To avoid repetition, details are not described herein again.

Referring to FIG. 5, FIG. 5 is a structural diagram of another cell reselection apparatus according to an embodiment of this application, and the apparatus is applied to a network side device. As shown in FIG. 5, the cell reselection apparatus 500 includes:
a sending module 501, configured to send a first indication to a terminal, where the first indication is used to instruct at least one of the following: ignoring or not applying, by the terminal, a first configuration in a cell reselection procedure, or applying, by the terminal, only a second configuration in the cell reselection procedure; and
the first configuration and the second configuration are used in the cell reselection procedure, and the second configuration is different from the first configuration.

In some embodiments, the sending module 501 is configured to: send a target configuration to the terminal, where the target configuration carries the first indication.

In some embodiments, the target configuration further includes a second indication, the second indication is used to indicate content of the first configuration, and the content of the first configuration includes at least one of the following:
a first network;
a first frequency; or
a first parameter.

In some embodiments, the first parameter is an inter-frequency or inter-RAT cell reselection parameter, and the first parameter includes at least one of the following:
a minimum required receive level in the cell;
a minimum required signal quality value in the cell;
a first threshold, where the first threshold is a cell selection signal quality threshold used by the terminal when performing cell reselection to a higher-priority RAT or frequency;
a second threshold, where the second threshold is a cell selection RX level value threshold used by the terminal when performing cell reselection to a higher-priority RAT or frequency;
a third threshold, where the third threshold is a cell selection RX level value threshold used by the terminal when performing cell reselection to a lower-priority RAT or frequency;
a fourth threshold, where the fourth threshold is a cell selection quality threshold used by the terminal when performing cell reselection to a lower-priority RAT or frequency;
a fifth threshold, where the fifth threshold is a cell selection quality threshold used by the terminal for a serving cell when performing cell reselection to a lower-priority RAT or frequency; or
a sixth threshold, where the sixth threshold is a cell selection quality threshold used by the terminal for a serving cell when performing cell reselection to a lower-priority RAT or frequency.

In some embodiments, the target configuration further includes a target value, and in a case that the terminal ignores or does not apply the first configuration in the cell reselection procedure, a value of the first configuration that is of the target cell and to be applied by the terminal is the target value.

In some embodiments, the target configuration further includes a first area configuration, and the first area configuration is used for indicating the terminal to perform the target operation within a first area.

In some embodiments, the first area configuration includes at least one of the following:
at least one tracking area identifier TAI;
at least one cell global identifier CGI;
at least one frequency and physical cell identifier PCI list;
at least one geographical area; or
at least one radio access network RAN area.

In some embodiments, the target configuration further includes a first time for indicating the terminal to perform the target operation within the first time.

In some embodiments, the first time is represented by at least one of the following:
a timer; or
a time window.

In some embodiments, in a case that the first time is represented by the timer, the first time is determined based on at least one of a length of the timer or a start point of the timer.

In some embodiments, in a case that the first time is represented by the time window the first time is determined based on any one of the following:
a length of the time window;
a start point and a length of the time window; or
a start point and an end point of the time window.

In some embodiments, the sending module 501 is configured to perform any one of the following:
sending the target configuration to the terminal via an RRC message, where the RRC message includes the target configuration;
sending the target configuration to the terminal via a NAS message, where the NAS message includes the target configuration; or
sending the target configuration to the terminal via a first message, where the first message includes the target configuration.

In some embodiments, the network side device is a core network device, and the sending module 501 is further configured to:
send a second message to a base station, where the second message includes at least one of the following:
the target configuration; or
a third indication, where the third indication is used to instruct the core network device to send the target configuration to the terminal.

The cell reselection apparatus 500 provided in this embodiment of this application can implement the processes implemented in the method embodiment in FIG. 3, and achieve a same technical effect. To avoid repetition, details are not described herein again.

As shown in FIG. 6, an embodiment of this application further provides a communication device 600, including a processor 601 and a memory 602. The memory 602 stores a program or an instruction that can be run on the processor 601. For example, when the communication device 600 is a terminal, the program or the instruction is performed by the processor 601 to implement the steps of the foregoing cell reselection method embodiment, and a same technical effect can be achieved. When the communication device 600 is a network side device, the program or the instruction is performed by the processor 601 to implement the processes of the foregoing cell reselection method embodiment, and a same technical effect can be achieved. To avoid repetition, details are not described herein again.

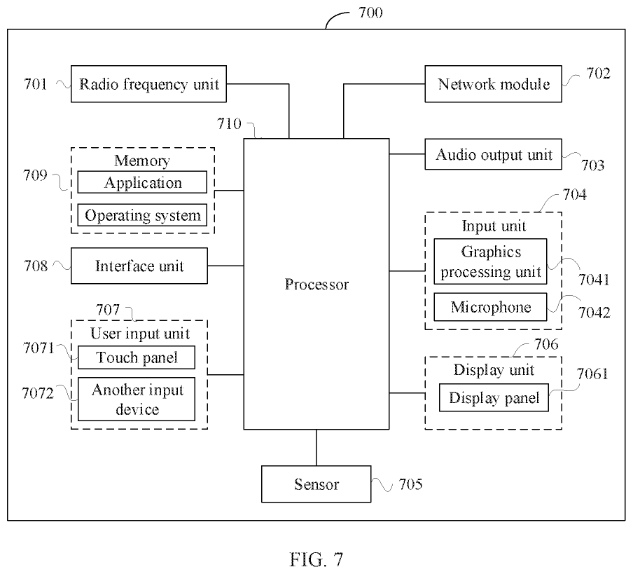

An embodiment of this application further provides a terminal, including a processor and a communication interface. The communication interface is coupled to the processor, and the processor is configured to run a program or an instruction to implement the steps of the method embodiment shown in FIG. 2. This terminal embodiment corresponds to the foregoing method embodiment on the terminal side. Each implementation process and implementation of the foregoing method embodiment may be applicable to this terminal embodiment, and a same technical effect can be achieved. For example, FIG. 7 is a schematic structural diagram of hardware of a terminal according to an embodiment of this application.

The terminal 700 includes but is not limited to a part of components such as a radio frequency unit 701, a network module 702, an audio output unit 703, an input unit 704, a sensor 705, a display unit 706, a user input unit 707, an interface unit 708, a memory 709, and a processor 710.

A person skilled in the art can understand that the terminal 700 may further include the power supply (for example, a battery) that supplies power to each component. The power supply may be logically connected to the processor 710 via a power supply management system, so as to manage functions such as charging, discharging, and power consumption via the power supply management system. The terminal structure shown in FIG. 7 constitutes no limitation on the terminal, and the terminal may include more or fewer components than those shown in the figure, or combine some components, or have different component arrangements. Details are not described herein.

It should be understood that, in this embodiment of this application, the input unit 704 may include a Graphics Processing Unit (GPU) 7041 and a microphone 7042, and the graphics processing unit 7041 processes image data of a still image or a video that is obtained by an image capturing apparatus (for example, a camera) in a video capturing mode or an image capturing mode. The display unit 706 may include a display panel 7061. The display panel 7061 may be configured in a form such as a liquid crystal display or an organic light-emitting diode. The user input unit 707 includes at least one of a touch panel 7071 and another input device 7072. The touch panel 7071 is also referred to as a touchscreen. The touch panel 7071 may include two parts: a touch detection apparatus and a touch controller. The another input device 7072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 701 may transmit the downlink data to the processor 710 for processing. In addition, the radio frequency unit 701 may send uplink data to the network side device. Usually, the radio frequency unit 701 includes but is not limited to an antenna, an amplifier, a transceiver, a coupler, a low noise amplifier, a duplexer, and the like.

The memory 709 may be configured to store a software program or an instruction and various data. The memory 709 may mainly include a first storage area for storing a program or an instruction and a second storage area for storing data. The first storage area may store an operating system, and an application or an instruction required by at least one function (for example, a sound playing function or an image playing function). In addition, the memory 709 may include a volatile memory or a non-volatile memory. The nonvolatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch link DRAM (SLDRAM), and a Direct Rambus RAM (DRRAM). The memory 709 in this embodiment of this application includes but is not limited to these memories and a memory of any other proper type.

The processor 710 may include one or more processing units. In some embodiments an application processor and a modem processor are integrated into the processor 710. The application processor mainly processes an operating system, a user interface, an application, and the like. The modem processor mainly processes a wireless communication signal, for example, a baseband processor. It can be understood that, for example, the modem processor may not be integrated into the processor 710.

The radio frequency unit 701 is configured to receive a first indication sent by a network side device, where the first indication is used to instruct at least one of the following: ignoring or not applying, by the terminal, a first configuration in a cell reselection procedure, or applying, by the terminal, only a second configuration in the cell reselection procedure; and
the processor 710 is configured to perform a target operation according to the first indication, where the target operation includes at least one of the following:
ignoring or not applying the first configuration of a target cell in the cell reselection procedure; or
applying only a configuration corresponding to the target cell in the second configuration in the cell reselection procedure, where
the target cell is a candidate cell for performing cell reselection by the terminal or a serving cell of the terminal, the first configuration and the second configuration are used in the cell reselection procedure, and the second configuration is different from the first configuration.

In this embodiment of this application, a network side device configures behavior of a terminal in a cell reselection procedure, so that the terminal can perform a target operation in the cell reselection procedure according to the configuration of the network side device, the operation behavior of the terminal is more controllable, and the network side device can learn the operation behavior of the terminal in the cell reselection procedure. This helps the network side device make timely adjustment when the terminal accesses an inappropriate network, so that the terminal is prevented from suffering a network attack, and a risk of the network attack on the terminal is more controllable.

It can be understood that, for an implementation process of each implementation mentioned in this embodiment, reference may be made to the related descriptions of the method embodiment in FIG. 2, and each process of the method embodiment in FIG. 2 can be implemented, and a same or corresponding technical effect is achieved. To avoid repetition, details are not described herein again.

An embodiment of this application further provides a network side device, including a processor and a communication interface. The communication interface is coupled to the processor, and the processor is configured to run a program or an instruction to implement the steps of the method embodiment shown in FIG. 3. This network side device embodiment corresponds to the foregoing method embodiment on the network side device. Each implementation process and implementation of the foregoing method embodiment may be applicable to this network side device embodiment, and a same technical effect can be achieved.

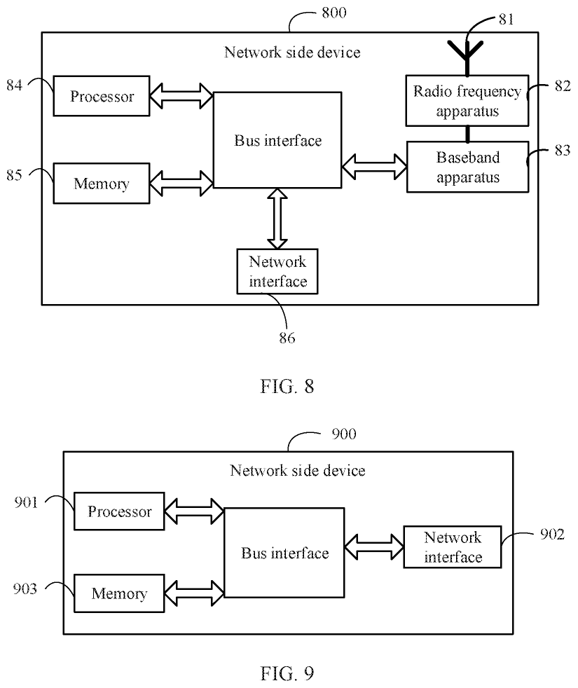

An embodiment of this application further provides a network side device. As shown in FIG. 8, the network side device 800 includes an antenna 81, a radio frequency apparatus 82, a baseband apparatus 83, a processor 84, and a memory 85. The antenna 81 is connected to the radio frequency apparatus 82. In an uplink direction, the radio frequency apparatus 82 receives information by using the antenna 81, and sends the received information to the baseband apparatus 83 for processing. In a downlink direction, the baseband apparatus 83 processes information that needs to be sent, and sends processed information to the radio frequency apparatus 82. The radio frequency apparatus 82 processes the received information, and sends processed information by using the antenna 81.

In the foregoing embodiment, the method performed by the network side device may be implemented in the baseband apparatus 83. The baseband apparatus 83 includes a baseband processor.

The baseband apparatus 83 may include, for example, at least one baseband board, where a plurality of chips are disposed on the baseband board. As shown in FIG. 8, one chip, for example, the baseband processor, is connected to the memory 85 through a bus interface, to invoke a program in the memory 85 to perform the operations of the network device shown in the foregoing method embodiment.

The network side device may further include a network interface 86, and the interface is, for example, a Common Public Radio Interface (CPRI).

The network side device 800 in this embodiment of this application further includes an instruction or a program that is stored in the memory 85 and that can be run on the processor 84. The processor 84 invokes the instruction or the program in the memory 85 to perform the method performed by the modules shown in FIG. 5, and a same technical effect is achieved. To avoid repetition, details are not described herein again.

An embodiment of this application further provides a network side device. As shown in FIG. 9, a network side device 900 includes a processor 901, a network interface 902, and a memory 903. The network interface 902 is, for example, a common public radio interface (CPRI).

The network side device 900 in this embodiment of this application further includes an instruction or a program that is stored in the memory 903 and that can be run on the processor 901. The processor 901 invokes the instruction or the program in the memory 903 to perform the method performed by the modules shown in FIG. 5, and a same technical effect is achieved. To avoid repetition, details are not described herein again.

An embodiment of this application further provides a readable storage medium. The readable storage medium stores a program or an instruction, and the program or the instruction is performed by a processor to implement the processes of the method embodiment in FIG. 2 or the processes of the method embodiment in FIG. 3, and a same technical effect can be achieved. To avoid repetition, details are not described herein again.

The processor is a processor in the terminal in the foregoing embodiment. The readable storage medium includes a computer readable storage medium, such as a computer read-only memory ROM, a random access memory RAM, a magnetic disk, or an optical disc. In some examples, the readable storage medium may be a non-transient readable storage medium.

An embodiment of this application further provides a chip. The chip includes a processor and a communication interface, the communication interface is coupled to the processor, and the processor is configured to run a program or an instruction to implement the processes of the method embodiment in FIG. 2 or the processes of the method embodiment in FIG. 3, and a same technical effect can be achieved. To avoid repetition, details are not described herein again.

It should be understood that the chip mentioned in this embodiment of this application may also be referred to as a system-level chip, a system chip, a chip system, or an on-chip system chip.

An embodiment of this application further provides a computer program/program product. The computer program/program product is stored in a storage medium, and the program/program product is performed by at least one processor to implement the processes of the method embodiment in FIG. 2 or the processes of the method embodiment in FIG. 3, and a same technical effect can be achieved. To avoid repetition, details are not described herein again.

An embodiment of this application further provides a communication system, including a terminal and a network side device. The terminal may be configured to perform the steps of the foregoing cell reselection method, and the network side device may be configured to perform the steps of the foregoing cell reselection method.

It should be noted that, in this specification, the terms “include”, “comprise”, or their any other variant are intended to cover a non-exclusive inclusion, so that a process, a method, an article, or an apparatus that includes a list of elements not only includes those elements but also includes other elements which are not expressly listed, or further includes elements inherent to such process, method, article, or apparatus. An element preceded by “includes a . . . ” does not, without more constraints, preclude the presence of additional identical elements in the process, method, article, or apparatus that includes the element. In addition, it should be noted that the scope of the method and the apparatus in the embodiments of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the foregoing descriptions of the embodiments, a person skilled in the art may clearly understand that the foregoing method embodiment may be implemented by computer software product in addition to a necessary general hardware platform or by hardware. The computer software product is stored in a storage medium (for example, a ROM, a RAM, a magnetic disk, or an optical disc) and includes several instructions, so that the terminal or the network side device performs the methods described in the embodiments of this application.

The embodiments of this application are described above with reference to the accompanying drawings, but this application is not limited to the above specific implementations, and the above specific implementations are merely illustrative but not restrictive. Under the enlightenment of this application, a person of ordinary skill in the art can make many forms of implementations without departing from the purpose of this application and the protection scope of the claims, all of which fall within the protection of this application.

1. A cell reselection method, comprising:
receiving, by a terminal, a first indication sent by a network side device, wherein the first indication is used to instruct at least one of the following: ignoring or not applying, by the terminal, a first configuration in a cell reselection procedure, or applying, by the terminal, only a second configuration in the cell reselection procedure; and
performing, by the terminal, a target operation according to the first indication, wherein the target operation comprises at least one of the following:
ignoring or not applying the first configuration of a target cell in the cell reselection procedure; or
applying only a configuration corresponding to the target cell in the second configuration in the cell reselection procedure,
wherein the target cell is a candidate cell for performing cell reselection by the terminal or a serving cell of the terminal, the first configuration and the second configuration are used in the cell reselection procedure, and the second configuration is different from the first configuration.

2. The cell reselection method according to claim 1, wherein the first indication is carried in a target configuration, and the performing, by the terminal, a target operation according to the first indication comprises:
performing, by the terminal, the target operation according to the target configuration.

3. The cell reselection method according to claim 2, wherein the target configuration further comprises a second indication, the second indication is used to indicate content of the first configuration, and the content of the first configuration comprises at least one of the following:
a first network;
a first frequency; or
a first parameter.

4. The cell reselection method according to claim 1, wherein content of the first configuration comprises at least one of the following:
a first network;
a first frequency; or
a first parameter,
wherein the first network, the first frequency, or the first parameter is preconfigured or is specified in a protocol.

5. The cell reselection method according to claim 3, wherein the first parameter is an inter-frequency or inter-Radio Access Technology (inter-RAT) cell reselection parameter, and the first parameter comprises at least one of the following:
a minimum required receive level in the cell;
a minimum required signal quality value in the cell;
a first threshold, wherein the first threshold is a cell selection signal quality threshold used by the terminal when performing cell reselection to a higher-priority Radio Access Technology (RAT) or frequency;
a second threshold, wherein the second threshold is a cell selection RX level value threshold used by the terminal when performing cell reselection to a higher-priority RAT or frequency;
a third threshold, wherein the third threshold is a cell selection RX level value threshold used by the terminal when performing cell reselection to a lower-priority RAT or frequency;
a fourth threshold, wherein the fourth threshold is a cell selection quality threshold used by the terminal when performing cell reselection to a lower-priority RAT or frequency;
a fifth threshold, wherein the fifth threshold is a cell selection quality threshold used by the terminal for a serving cell when performing cell reselection to a lower-priority RAT or frequency; or
a sixth threshold, wherein the sixth threshold is a cell selection quality threshold used by the terminal for a serving cell when performing cell reselection to a lower-priority RAT or frequency.

6. The cell reselection method according to claim 5, wherein when the target configuration comprises the first parameter, or the first parameter is preconfigured or is specified in the protocol, the performing, by the terminal, a target operation comprises at least one of the following:
ignoring or not applying, by the terminal, the minimum receive level value required by the target cell;
ignoring or not applying, by the terminal, the minimum signal quality value required by the target cell;
when the minimum receive level value required by the target cell is configured to be greater than or equal to a first value, ignoring or not applying, by the terminal, the minimum receive level value required by the target cell;
when the minimum signal quality value required by the target cell is configured to be greater than or equal to a second value, ignoring or not applying, by the terminal, the minimum signal quality value required by the target cell;
ignoring or not applying, by the terminal, the first threshold;
ignoring or not applying, by the terminal, the second threshold;
ignoring or not applying, by the terminal, the third threshold;
ignoring or not applying, by the terminal, the fourth threshold;
ignoring or not applying, by the terminal, the fifth threshold;
ignoring or not applying, by the terminal, the sixth threshold;
when the first threshold is configured to be less than or equal to a third value, ignoring or not applying, by the terminal, the first threshold;
when the second threshold is configured to be less than or equal to a fourth value, ignoring or not applying, by the terminal, the second threshold;
when the third threshold is configured to be less than or equal to a fifth value, ignoring or not applying, by the terminal, the third threshold;
when the fourth threshold is configured to be less than or equal to a sixth value, ignoring or not applying, by the terminal, the fourth threshold;
when the fifth threshold is configured to be greater than or equal to a seventh value, ignoring or not applying, by the terminal, the fifth threshold; or
when the sixth threshold is configured to be greater than or equal to an eighth value, ignoring or not applying, by the terminal, the sixth threshold.

7. The cell reselection method according to claim 6, further comprising at least one of the following:
when the terminal ignores or does not apply the minimum receive level value required by the target cell, considering, by the terminal, the minimum receive level value required by the target cell as a first target value;
when the terminal ignores or does not apply the minimum signal quality value required by the target cell, considering, by the terminal, the minimum signal quality value required by the target cell as a second target value;
when the terminal ignores or does not apply the first threshold, considering, by the terminal, the first threshold as a third target value;
when the terminal ignores or does not apply the second threshold, considering, by the terminal, the second threshold as a fourth target value;
when the terminal ignores or does not apply the third threshold, considering, by the terminal, the third threshold as a fifth target value;
when the terminal ignores or does not apply the fourth threshold, considering, by the terminal, the fourth threshold as a sixth target value;
when the terminal ignores or does not apply the fifth threshold, considering, by the terminal, the fifth threshold as a seventh target value; or
when the terminal ignores or does not apply the sixth threshold, considering, by the terminal, the sixth threshold as an eighth target value.

8. The cell reselection method according to claim 3, wherein the first parameter is a parameter corresponding to a frequency of the first network or a parameter corresponding to the first frequency.

9. The cell reselection method according to claim 3, wherein when the target configuration comprises the first network, or the first network is preconfigured or is specified in the protocol, the performing, by the terminal, a target operation comprises at least one of the following:
ignoring or not applying, by the terminal, the first network;
ignoring or not applying, by the terminal, a frequency of the first network; or
ignoring or not applying, by the terminal, a priority that is of the frequency of the first network and configured by a first cell, wherein the first cell is a serving cell of the terminal.

10. The cell reselection method according to claim 9, wherein the ignoring or not applying, by the terminal in the cell reselection procedure, a priority that is of the frequency of the first network and configured by a first cell comprises at least one of the following:
determining, by the terminal, the frequency of the first network as a lowest-priority frequency;
determining, by the terminal, a value of the priority of the frequency of the first network as a ninth value; or
considering, by the terminal, that the priority of the frequency of the first network is not provided.

11. The cell reselection method according to claim 9, wherein the ignoring or not applying, by the terminal, the first configuration of a target cell in the cell reselection procedure comprises:
when the priority of the frequency of the first network is greater than or equal to a seventh threshold, ignoring or not applying, by the terminal, the first configuration of the target cell in the cell reselection procedure.

12. The cell reselection method according to claim 3, wherein when the target configuration comprises the first frequency, or the first frequency is preconfigured or is specified in the protocol, the performing, by the terminal, a target operation comprises at least one of the following:
ignoring or not applying, by the terminal, the first frequency; or
ignoring or not applying, by the terminal, a priority that is of the first frequency and configured by a first cell, wherein the first cell is a serving cell of the terminal.

13. The cell reselection method according to claim 12, wherein the ignoring or not applying, by the terminal, a priority that is of the first frequency and configured by a first cell comprises at least one of the following:
determining, by the terminal, the first frequency as a lowest-priority frequency;
determining, by the terminal, a value of the priority of the first frequency as a tenth value; or
considering, by the terminal, that the priority of the first frequency is not provided.

14. The cell reselection method according to claim 12, wherein the ignoring or not applying, by the terminal, the first configuration of a target cell in the cell reselection procedure comprises:
when the priority of the at least one first frequency is greater than or equal to an eighth threshold, ignoring or not applying, by the terminal, the first configuration of the target cell in the cell reselection procedure.

15. The cell reselection method according to claim 2, wherein the target configuration further comprises a target value, and when the terminal ignores or does not apply the first configuration in the cell reselection procedure, a value of the first configuration that is of the target cell and to be applied by the terminal is the target value.

16. The cell reselection method according to claim 2, wherein the target configuration further comprises a first area configuration, and the first area configuration is used for indicating the terminal to perform the target operation within a first area.

17. The cell reselection method according to claim 16, wherein the first area configuration comprises at least one of the following:
at least one tracking area identifier (TAI);
at least one cell global identifier (CGI);
at least one frequency and physical cell identifier (PCI) list;
at least one geographical area; or
at least one radio access network (RAN) area.

18. The cell reselection method according to claim 2, wherein the target configuration further comprises a first time for indicating the terminal to perform the target operation within the first time.

19. A cell reselection method, comprising:
sending, by a network side device, a first indication to a terminal, wherein the first indication is used to instruct at least one of the following: ignoring or not applying, by the terminal, a first configuration in a cell reselection procedure, or applying, by the terminal, only a second configuration in the cell reselection procedure; and
the first configuration and the second configuration are used in the cell reselection procedure, and the second configuration is different from the first configuration.

20. A terminal, comprising: a memory storing a computer program; and a processor coupled to the memory and configured to execute the computer program to perform operations comprising:
receiving a first indication sent by a network side device, wherein the first indication is used to instruct at least one of the following: ignoring or not applying, by the terminal, a first configuration in a cell reselection procedure, or applying, by the terminal, only a second configuration in the cell reselection procedure; and
performing a target operation according to the first indication, wherein the target operation comprises at least one of the following:
ignoring or not applying the first configuration of a target cell in the cell reselection procedure; or
applying only a configuration corresponding to the target cell in the second configuration in the cell reselection procedure,
wherein the target cell is a candidate cell for performing cell reselection by the terminal or a serving cell of the terminal, the first configuration and the second configuration are used in the cell reselection procedure, and the second configuration is different from the first configuration.
